(19) United States
(12) Patent Application Publication
(10) Pub. No.: US 2015/0255799 A1
(43) Pub. Date: Sep. 10, 2015

(54) Apparatus and Method for the Synthesis and Treatment of Metal Monolayer Electrocatalyst Particles in Batch or Continuous Fashion

(71) Applicant: Brookhaven Science Associates, LLC, Upton, NY (US)

(72) Inventors: Radoslav Adzic, East Setauket, NY (US); Miomir Vukmirovic, Port Jefferson Station, NY (US)

(21) Appl. No.: 14/714,646

(22) Filed: May 18, 2015

Related U.S. Application Data
(62) Division of application No. 13/636,192, filed on Nov. 15, 2012.
(60) Provisional application No. 61/316,874, filed on Mar. 24, 2010.

(51) Int. Cl. H01M 4/88; C25D 17/10

(52) U.S. Cl. CPC H01M 4/8853; C25D 17/10

(57) ABSTRACT

An apparatus and method for the synthesis and treatment of electrocatalyst particles in batch or continuous fashion is provided. In one embodiment, the apparatus is comprised of a three-electrode cell which includes a reference electrode, a counter electrode, and a working electrode. The working electrode is preferably a cylindrical vessel having an electrically conductive region. The electrode assembly is introduced into a slurry containing metal ions and a plurality of particles. During operation an electrical potential is applied and the working electrode is rotated at a predetermined speed. When particles in the slurry collide with the electrically conductive region the transferred charge facilitates deposition of an adlayer of the desired metal. In this manner film growth can commence on a large number of particles simultaneously. This process is especially suitable as a commercial thin film deposition process for forming catalytically active layers on nanoparticles for use in energy conversion devices.

This application is an International PCT application, which claims the benefit of U.S. Provisional Application No. 61/316,874, filed on Mar. 24, 2010 which is hereby incorporated by reference in its entirety.

This invention was made with Government support under contract number DE-AC02-98CH10886, awarded by the U.S. Department of Energy. The Government has certain rights in the invention.

### BACKGROUND

I. Field of the Invention

This invention relates generally to the controlled deposition of ultrathin films. In particular, the present invention relates to an apparatus and method for depositing atomic submonolayer to multilayer thin films on a plurality of particles in batch or continuous fashion. The present invention also relates to nanoparticle electrocatalysts having ultrathin catalytically active layers formed using the disclosed apparatus and method.

II. Background of the Related Art

Metals such as platinum (Pt), palladium (Pd), ruthenium (Ru), and related alloys are known to be excellent catalysts. When incorporated in electrodes of an electrochemical device such as a fuel cell, these materials function as electrocatalysts since they accelerate electrochemical reactions at electrode surfaces yet are not themselves consumed by the overall reaction. Although noble metals have been shown to be some of the best electrocatalysts, their successful implementation in commercially available energy conversion devices is hindered by their high cost in combination with other factors such as a susceptibility to carbon monoxide (CO) poisoning, poor stability under cyclic loading, and the relatively slow kinetics of the oxygen reduction reaction (ORR).

A variety of approaches has been employed in attempting to address these issues. One approach involves increasing the overall surface area available for reaction by forming particles with nanometer-scale dimensions. Loading of more expensive noble metals such as Pt has been further reduced by forming nanoparticles from alloys comprised of Pt and a low-cost component. Still further improvements have been attained by forming core-shell nanoparticles in which a core particle is coated with a thin shell of a different material which functions as the electrocatalyst. The core is usually a low-cost material which is easily fabricated whereas the shell comprises a more catalytically active noble metal. An example is provided by U.S. Pat. No. 6,670,301 to Adzic, et al. which discloses a process for depositing a thin film of Pt on dispersed Ru nanoparticles supported by carbon (C) substrates. Another example is U.S. Patent Appl. Publ. No. 2006/0135359 to Adzic, et al. which discloses platinum- and platinum-alloy coated palladium and palladium alloy nanoparticles. Each of the aforementioned is incorporated by reference in its entirety as if fully set forth in this specification. Although these approaches have produced catalysts with a higher catalytic activity and reduced noble metal loading, realization of these enhancements on a commercial scale requires the development of large-scale and cost-effective manufacturing capabilities.

Practical synthesis of electrocatalyst particles with peak activity levels requires the development of commercially viable processes which are still capable of providing atomic-level control over the formation of ultrathin surface layers. Such a process must allow formation of uniform and conformal atomic-layer coatings of the desired material on a large number of three-dimensional particles having sizes as small as a few nanometers. One method of depositing a monolayer of Pt on particles of different metals involves the initial deposition of an atomic monolayer of a metal such as copper (Cu) by underpotential deposition (UPD). This is followed by galvanic displacement of the underlying Cu atoms by a more noble metal such as Pt as disclosed, for example, in U.S. Patent Application Publ. No. 2007/0264189 to Adzic, et al. Another method involves hydrogen adsorption-induced deposition of a monolayer of metal atoms on noble metal particles as described, for example, in U.S. Pat. No. 7,507,495 to Wang, et al. Each of the aforementioned is incorporated by reference in its entirety as if fully set forth in this specification.

Although these processes have been successful for small-scale experiments performed in the laboratory, their commercial realization will require the development of systems and methods capable of processing a large number of electrocatalyst particles to within very tight tolerances. There therefore is a continuing need in the art for the development of commercially viable systems and methods for processing electrocatalyst particles.

### SUMMARY

Having recognized the above and other considerations, the inventors determined that there is a need to develop a simple and cost-effective apparatus and process which provides atomic-level control over the deposition of uniform and conformal ultrathin films on a large number of three-dimensional particles. In exemplary embodiments of the present invention, the apparatus and method not only permit batch or continuous layer-by-layer deposition of films with thicknesses ranging from submonolayer to multilayer coverages, but they also allow atomic-level control over film uniformity on the surfaces of large quantities of three-dimensional particles having sizes down to the nanoscale range. In one embodiment this is accomplished using a rotating cylinder slurry cell.

In a preferred embodiment the apparatus comprises a cell for holding a slurry containing a plurality of particles, a first electrode, and a second electrode. The first electrode has a cylindrical body comprising a first electrically insulating section provided with a hollow channel through its interior, and an electrically conductive section which is connected to an external power source by means of a conducting medium which passes through the hollow channel. In an especially preferred embodiment the electrically insulating section is comprised of polytetrafluoroethylene, whereas the electrically conductive section is comprised of a material selected from the group consisting of titanium activated by a ruthenium coating, stainless steel, and glassy carbon. The first electrode is further configured to rotate about its longitudinal axis and may have a circular, oval, hexagonal, or octagonal cross-section. The second electrode typically consists of a good electrical conductor. In a preferred embodiment the second electrode is a thin platinum wire.

In another preferred embodiment the apparatus further comprises a third electrode which has a known reduction potential. The third electrode may be, for example, a normal hydrogen electrode (NHE) or a silver-silver chloride (Ag/AgCl) reference electrode. In a more preferred embodiment, the first electrode further comprises a second insulating section which is provided at an end of the first electrode such that the electrically conductive section is located between the first and second insulating sections. The cell itself may include a glass container, but is not so limited and may be any suitable container of sufficient rigidity and chemical inertness. The potential applied to the first electrode is controlled by means of an external power supply whereas the rotational speed of the first electrode is controlled by a rotational controller. In a preferred embodiment the power supply is capable of applying a voltage in the range of −1 to +1 Volts and the rotational controller is capable of rotating the first electrode at a rotational speed of 0 to 500 rotations per minute.

In still another embodiment, a method of forming a film on a substrate using a rotating cylinder slurry cell is disclosed. The method of forming a film on a substrate comprises initially preparing a slurry comprising a plurality of particles and an electrolyte having a predetermined concentration of ions of a material to be deposited as an adlayer. The particles are preferably microparticles or nanoparticles and the adlayer is preferably an element selected from the group consisting of Cu, Pb, Bi, Sn, Ce, Ag, Sb, and Tl. In one embodiment the slurry is prepared using one to twenty grams of nanoparticles in 200 ml to 2000 ml of electrolyte. By scaling of the apparatus to larger sizes, a larger quantity of particles, up to hundreds of grams, can be accommodated. The electrodes of a rotating cylinder slurry cell are then immersed in the slurry to facilitate thin film growth. In a preferred embodiment the slurry cell is an apparatus comprising a cell for holding a slurry containing a plurality of particles, a first electrode, and a second electrode. The first electrode typically comprises at least a first electrically insulating section provided with a hollow channel through its interior, and an electrically conductive section which is connected to an external power source by means of a conducting medium which passes through the hollow channel. The first electrode is also configured to rotate about a longitudinal axis whereas the second electrode is a thin wire which is a good electrical conductor.

Film growth proceeds by rotating the first electrode at a predetermined rotational speed and applying an electrical potential to the electrically conductive section of the first electrode for a specified duration. In a preferred embodiment the first electrode is rotated at a rotational speed of 100 rotations per minute. Application of an electrode potential to the first electrode facilitates film growth of up to one monolayer on the surface of the particles by underpotential deposition. After deposition of an adlayer, excess ions are then removed from the slurry and ions of a metal which is more noble than the material deposited as an adlayer are added to the slurry. This facilitates deposition of the more noble metal by galvanic displacement of atoms constituting the adlayer. In an especially preferred embodiment ions of a more noble metal are produced by adding a salt of one or more of PdCl₂, K₂PtCl₄, AUCl₃, IrCl₃, RuCl₃, OsCl₃, or ReCl₃.

In yet another embodiment film growth using the rotating cylinder slurry cell is performed in batch form. Using this approach a single batch of slurry is sequentially processed through each step of the deposition process. In still another embodiment the rotating cylinder slurry cell is configured for continuous operation. This approach involves feeding a continuous supply of slurry to the rotating cylinder slurry cell which, in turn, is operated continuously at a predetermined electrode potential and rotational speed.

The apparatus and method disclosed in this specification provide atomic-level control over film growth on a large number of particles, thereby making it suitable for commercial applications. It is especially advantageous in the production of electrocatalyst nanoparticles for use in energy conversion devices such as fuel cells, metal-air batteries, and supercapacitors.

### BRIEF DESCRIPTION OF THE DRAWINGS

FIG. 1 depicts the components of a rotating cylinder slurry cell.

FIG. 2 shows a series of images illustrating the underpotential deposition of an adlayer onto the surface of a core-shell nanoparticle followed by galvanic displacement by a more noble metal.

FIG. 3 is an atomic-scale cross-sectional schematic of a core-shell nanoparticle encapsulated by a monolayer of a catalytically active metal.

FIG. 4 is a flowchart showing the sequence of steps performed during film growth using the rotating cylinder slurry cell.

### DETAILED DESCRIPTION

These and other aspects of the invention will become more apparent from the following description and illustrative embodiments which are described in detail with reference to the accompanying drawings. In the interest of clarity, in describing the present invention, the following terms and acronyms are defined as provided below.

### Acronyms

MWNT: Multi-walled nanotube
NHE: Normal hydrogen electrode
ORR: Oxidation reduction reaction
SWNT: Single-walled nanotube
UPD: Underpotential deposition

### Definitions

Adatom: An atom located on the surface of an underlying substrate.
Adlayer: A layer of atoms or molecules adsorbed onto the surface of a substrate.
Bilayer: Two consecutive layers of atoms or molecules which occupy available surface sites on each layer and coat substantially the entire exposed surface of the substrate.
Catalysis: A process by which the rate of a chemical reaction is increased by means of a substance (a catalyst) which is not itself consumed by the reaction.
Electrocatalysis: The process of catalyzing a half cell reaction at an electrode surface by means of a substance (an electrocatalyst) which is not itself consumed by the reaction.
Electrodeposition: Another term for electroplating.
Electroplating: The process of using an electrical current to reduce cations of a desired material from solution to coat a conductive substrate with a thin layer of the material.
Monolayer: A single layer of atoms or molecules which occupies available surface sites and covers substantially the entire exposed surface of a substrate.
Multilayer: More than one layer of atoms or molecules on the surface, with each layer being sequentially stacked on top of the preceding layer.
Nanoparticle: Any manufactured structure or particle with at least one nanometer-scale dimension, i.e., 1-100 nm
Nanostructure: Any manufactured structure with nanometer-scale dimensions.
Noble metal: A metal that is extremely stable and inert, being resistant to corrosion or oxidation. These generally comprise ruthenium (Ru), rhodium (Rh), palladium (Pd), silver (Ag), rhenium (Re), osmium (Os), iridium (Ir), platinum (Pt), and gold (Au). Noble metals are frequently used as a passivating layer.
Non-noble metal: A transition metal which is not a noble metal.
Redox reaction: A chemical reaction wherein an atom undergoes a change in oxidation number. This typically involves the loss of electrons by one entity accompanied by the gain of electrons by another entity.
Refractory metal: A class of metals with extraordinary resistance to heat and wear, but with generally poor resistance to oxidation and corrosion. These generally comprise tungsten (W), molybdenum (Mo), niobium (Nb), tantalum (Ta), and rhenium (Re).
Slurry: A suspension of solids in a liquid.
Submonolayer: Surface atomic or molecular coverages which are less than a monolayer.
Transition metal: Any element in the d-block of the periodic table which includes groups 3 to 12.
Trilayer: Three consecutive layers of atoms or molecules which occupy available surface sites on each layer and coat substantially the entire exposed surface of the substrate.
Underpotential Deposition: A phenomenon involving the electrodeposition of a species at a potential which is positive with respect to the equilibrium or Nernst potential for the reduction of the metal.

This invention is based on the development of an apparatus and method for the simultaneous deposition of atomically thin films on a large number of particles in batch or continuous fashion. The apparatus, which is described as a rotating cylinder slurry cell throughout this specification, is based on the concept of a moving electrode immersed in a slurry comprising the particles. Continuous movement of the electrode induces collisions between the electrode surface and particles contained within the slurry. By application of the appropriate electrical potential, particles that come into contact with the moving electrode acquire the charge necessary for an atomic layer of the desired material to deposit by underpotential deposition (UPD). The continuous motion of the electrode ensures that uncoated particles within the slurry continually come into contact with the electrode to form the desired adlayer.

After substantially all of the particles have been coated with an initial adlayer, the excess metal ions in solution are removed and a catalytically active surface layer is formed by exposing the particles to a salt of a metal which is more noble than the adlayer. Deposition of the catalytically active surface layer then occurs by galvanic displacement of the UPD adlayer by the more noble metal. The apparatus can conceivably be used with any type, size, and shape of particle which can be formed into a slurry and undergo film growth by UPD, as a result of contacting an electrode having an applied potential. Regardless of the type of particle used as the substrate, the apparatus is suitable for commercial manufacturing processes since it facilitates the controlled deposition of ultrathin films with atomic-level control on a large number of these particles in batch or continuous fashion.

### I. Particle Synthesis

Particles of carbon, a suitable metal, or metal alloy are initially prepared using any technique which is well-known in the art. It is to be understood, however, that the invention is not limited to deposition onto metal or carbon-based particles and may include other materials which are well-known in the art including semiconductors and oxides. It is these particles onto which a thin film of the desired material will be deposited. The particles are preferably nanoparticles with sizes ranging from 2 to 100 nm in one or more dimensions. However, the size is not so limited and may extend into the micrometer and millimeter size range.

In one embodiment, the nanoparticles comprise a metal, metal alloy, and/or core-shell particles. It is also to be understood that the metal, metal alloy, and/or core-shell particles may take on any shape, size, and structure as is well-known in the art including, but not limited to, branching, conical, pyramidal, cubical, mesh, fiber, cuboctahedral, and tubular nanoparticles. The nanoparticles may be agglomerated or dispersed, formed into ordered arrays, fabricated into an interconnected mesh structure, either formed on a supporting medium or suspended in a solution, and may have even or uneven size distributions. The particle shape and size is preferably such that the bonding configuration of surface atoms is such that their reactivity and, hence, their ability to function as a catalyst, is increased.

In another embodiment the nanoparticles are in the form of nanostructured carbon substrates. Examples of carbon nanostructures include, but are not limited to carbon nanoparticles, nanofibers, nanotubes, fullerenes, nanocones, and/or nanohoms. Within this specification, the primary carbon nanostructures discussed are carbon nanotubes and nanohorns. However, it is to be understood that the carbon nanostructures used are not limited to these particular structures. Carbon nanotubes are identified as nanometer-scale cylindrical structures of indeterminate length comprised of sp²-bonded carbon atoms. The nanotube may be a single-walled nanotube (SWNT) or a multi-walled nanotube (MWNT). A higher specific surface area may be obtained using carbon nanohorns which have a structure analogous to nanotubes, but with one end of the cylindrical tube closed and the other open, resulting in a horn-like shape. Carbon nanohorns generally possess a higher specific surface area than carbon nanotubes and an average pore size (on the order of tens of nm) which is larger than both carbon nanotubes and activated carbon or carbon fibers.

This specification will use film growth on core-shell nanoparticles as an embodiment which exemplifies the spirit and scope of the present invention. It is to be understood, however, that any suitable particle as described above may be used with the apparatus. Methods for producing the various types of nanoparticles and depositing ultrathin surface layers by UPD and galvanic displacement have been previously described in U.S. patent application Ser. No. 12/709,910 filed Feb. 22, 2010 in the names of R. Adzic, M. Vukmirovic, and W. Zhou, which is incorporated by reference in its entirety as if fully set forth in this specification. Production of carbon nanostructures and depositing ultrathin surface layers by UPD and galvanic displacement has previously been described in U.S. patent application Ser. No. 12/709,836 filed Feb. 22, 2010 in the names of R. Adzic and A. Harris, which is incorporated by reference in its entirety as if fully set forth in this specification.

### II. Ultrathin Film Growth

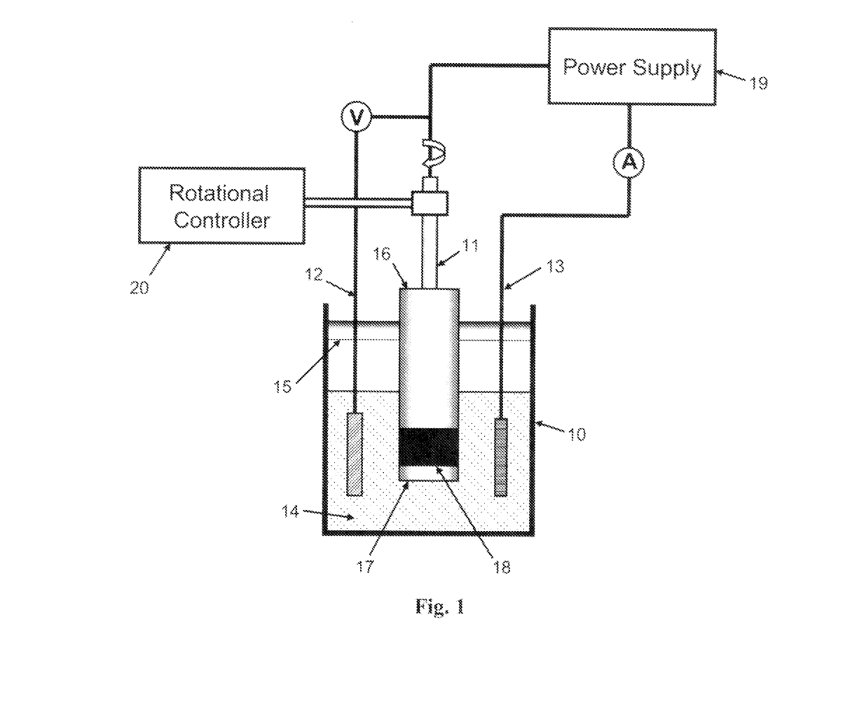

Once nanoparticles having the desired shape, composition, and size distribution have been fabricated, it is necessary to produce a suspension or slurry of these particles so that the desired ultrathin films may then be deposited. Film growth is accomplished by UPD using a rotating cylinder slurry cell, an embodiment of which is illustrated in FIG. 1. The rotating cylinder slurry cell permits the controllable deposition of ultrathin films having thicknesses in the submonolayer-to-multilayer thickness range onto a large number of particles in batch or continuous fashion.

For purposes of this specification, a monolayer is formed when the substrate surface is substantially fully covered by a single layer comprising adatoms which form a chemical or physical bond with the atoms of the underlying substrate. If the surface is not substantially completely covered, e.g., substantially fewer than all available surface sites are occupied by an adatom, then the surface coverage is termed submonolayer. However, if additional layers are deposited onto the first layer, then multilayer coverages result. If two successive layers are formed, then it is termed a bilayer and if three successive layers are formed, then the resultant film is a trilayer and so on. The materials chemistry underlying the present invention may be best understood through an initial description of the rotating cylinder slurry cell. This is followed by a description of the principles governing growth by underpotential deposition.

### A. Rotating Cylinder Slurry Cell

The structure of a rotating cylinder slurry cell is illustrated in FIG. 1. In a preferred embodiment the cell (10) comprises three electrodes which are identified as the working electrode (11), the reference electrode (12), and the counter electrode (13). The three electrodes are immersed in a cell (10) containing a slurry (14) comprised of the desired particles in an electrolyte. Each of the electrodes is generally secured into position using a suitable cover (15). The working electrode (11) is configured such that it is capable of rotating about a longitudinal axis while an electrical potential is simultaneously applied. Although the working electrode (11) is shown and described as a cylinder having a circular cross-section, other cross-sectional shapes such an oval, hexagon, and octagon can conceivably be used. In another embodiment the working electrode (11) may be screw-shaped to facilitate agitation of the slurry (14) during rotation. The cell (10) preferably includes a glass container, but can be constructed of any material which is electrically insulating and is capable of holding solutions of a corrosive nature.

The working electrode (11) typically has three separate components: a top shaft (16), a bottom shaft (17), and a rotating electrode (18). The top (16) and bottom (17) shafts are preferably made of a corrosive-resistant material such as polytetrafluoroethylene whereas the rotating electrode (18) is preferably made of an electrically conductive material which is stable in corrosive solutions at positive potentials. Some examples of materials which may be used as the rotating electrode (18) include titanium (Ti) activated by a ruthenium (Ru) coating, stainless steel, and glassy carbon. Although the size of the rotating electrode (18) can vary widely and is typically configured to a particular application, in a preferred embodiment it is a cylinder 1 cm in diameter by 1 cm high. The top shaft (16) typically has a hollow interior though which a conducting material such as a wire or rod may be provided so that the appropriate potential can be applied to the rotating electrode (18). The top shaft (16), bottom shaft (17), and rotating electrode (18) are preferably affixed to each other in a manner that provides a water-tight seal such that the slurry (14) cannot leak into the working electrode (11) at the interface between components.

The rotating cylinder slurry cell is also provided with an external power supply (19) and rotational controller (20). The power supply (19) is capable of applying the desired electrical potential to the working electrode (11) whereas the rotational controller (20) is used to control its rotational speed. Some typical operating parameters include a rotational speed of between 0 to 500 rotations per minute (rpm) and an applied potential of −1 to +1 Volts. In a preferred embodiment, the rotational speed is between 10 and 200 rpm. The actual parameters used, of course, depend upon the particular size and configuration of the rotating cylinder slurry cell as well as the constituents of the slurry (14).

The reaction of interest occurs between the slurry (14) and the exposed surfaces of the rotating electrode (18). The half-cell reactivity of the slurry (14) can be measured by varying the potential applied to the working electrode (11) and then measuring the resulting current flow. The counter electrode (13) serves as the other half of the half-cell and balances the electrons which are added or removed at the working electrode (11). In order to determine the potential of the working electrode (11), the potential of the counter electrode (13) must be known. Completion of the redox reactions occurring at the exposed surfaces of the rotating electrode (18) requires that a constant potential be maintained at both electrodes while the necessary current is permitted to flow. In practice this is difficult to accomplish using a two-electrode system. This issue may be resolved by introducing the reference electrode (12) to divide the role of supplying electrons and maintaining a reference potential between two separate electrodes. The reference electrode (12) is a half cell with a known reduction potential. It acts as a reference in the measurement and control of the potential of the rotating electrode (18). The reference electrode (12) does not pass any current to or from the electrolyte; all current needed to balance the reactions occurring at the rotating electrode (18) flows through the counter electrode (13).

The sole purpose of the counter electrode (13) is to permit the flow of electrical current from the slurry (14). Consequently the counter electrode (13) can be made of nearly any material as long as it is a good conductor and does not react with the electrolyte. Most counter electrodes (13) are fabricated from Pt wire since Pt is a good electrical conductor and is electrochemically inert. The wire may be of any thickness, but it is typically thin. Although the counter electrode (13) in FIG. 1 is provided in the same cell (10) as the working electrode (11), in alternative embodiments it is conceivable that the counter electrode (13) can be provided in a separate cell (10). The reference electrode (12) has a stable and well-known electrode potential which is usually attained by means of a redox system having constant concentrations of each participant in the redox reaction. Examples include a normal hydrogen electrode (NHE) and a silver-silver chloride (Ag/AgCl) reference electrode. The reference electrode (12) provides a standard potential against which the potential at the rotating electrode (18) can be measured.

In a typical setup, the reference electrode (12) and counter electrode (13) of the three-electrode electrochemical cell are static and sit in unstirred regions of the desired slurry (14) whereas the working electrode (11) is rotated at a constant angular velocity. This rotation provides a flux of particles toward the rotating electrode (18) and therefore facilitates collisions between particles in the slurry and the rotating electrode (18) where they come into electrical contact and are given the charge necessary to facilitate film growth. The rotational speed is chosen such that the flux of incoming and outgoing particles is balanced and the probability of electrical contact between the rotating electrode (18) and the particles is maximized. Preferred rotational speeds typically range from 10 to 200 rpm. In alternate embodiments, it is envisioned that agitation of the slurry may be achieved by means other than rotation of the working electrode (11). However, other types of agitation may result in a random flux of particles onto the electrode. The electrochemical reactions occurring through the exposed surface of the rotating electrode (18) can be controlled and analyzed by varying the electrode potential with time and measuring the resulting current flow. The potential is measured between the reference electrode (12) and the working electrode (11) whereas the current is measured between the working electrode (11) and the counter electrode (13).

The applied potential can be changed linearly with time such that oxidation or reduction of species at the electrode surface can be analyzed through changes in the current signal as is typically performed during linear voltammetry measurements. Although the applied potential preferably ranges from -1 to +1 volts, the exact potential range used depends on the specifics of a particular configuration, including parameters such as the type of particles and UPD element. As an example, for the UPD of Cu, the applied potential typically ranges from 0.05 to 0.5 V versus a silver/silver chloride (Ag/AgCl, Cl⁻) reference electrode. Oxidation is registered as an increase in current whereas reduction results in a decrease in the current signal. The resultant peaks and troughs can be analyzed and information on the kinetics and thermodynamics of the system can be extracted. If the slurry (14) is redox active it may display a reversible wave in which the slurry (14) is reduced (or oxidized) during a linear sweep in the forward direction and is oxidized (or reduced) in a predictable manner when the potential is stopped and then swept in the reverse direction such as during cyclic voltammetry.

In conventional electrodeposition a cation contained in solution is reduced by the flow of electrical current through a conductive substrate. At the substrate surface, electrons combine with and thereby reduce cations in solution to form a thin film on the surface of the substrate itself. In order for the overall reaction to proceed, the reduction of cations at one electrode must be counterbalanced by oxidation at a second electrode. In a standard electroplating setup the part to be plated is the cathode whereas oxidation occurs at the anode. The cathode is connected to the negative terminal of an external power supply whereas the anode is connected to the positive terminal. When the power supply is activated, the material constituting the anode is oxidized to form cations with a positive charge whereas cations in solution are reduced and thereby plated onto the surface of the cathode. The cathode and anode in an electroplating cell are analogous to the working electrode (11) and counter electrode (13), respectively, in the three-terminal cell of FIG. 1.

For conventional metals there is generally a bulk deposition potential (or Nernst potential) which is necessary for deposition of the metal itself to proceed. It is known that for certain metals it is possible to deposit a single monolayer or bilayer of the metal onto a substrate of a different metal at potentials positive to the bulk deposition potential. In this case, formation of the metal monolayer occurs before bulk deposition can proceed. This phenomenon is known as underpotential deposition (UPD) and it occurs when the adatom-substrate bonding is stronger than the adatom-adatom bonding. An example is provided by Brankovic, et al. which discloses the use of UPD to form an adlayer of Cu onto Pd substrates in “Metal Monolayer Deposition by Replacement of Metal Adlayers on Electrode Surfaces” Surf. Sci., 474, L173 (2001) which is incorporated by reference in its entirety as if fully set forth in this specification. The process used to form adlayers by UPD is generally reversible. By sweeping the applied potential in one direction, a monolayer of the desired material may be deposited whereas a sweep in the reverse direction results in desorption of the thus-formed monolayer.

When the working electrode (11) is rotated it facilitates constant and repeated collisions between particles in the slurry (14) and the exposed surfaces of the rotating electrode (18). When contact is made, charge is transferred from the rotating electrode (18) to the particle such that metal ions in solution are reduced and deposited onto the surface of the particle by UPD. The continuous rotating action agitates the slurry (14) such that uncoated particles continuously come into contact with the rotating electrode (18). In this manner, a thin film can be deposited onto substantially all of the particles in a single batch. When one batch is complete, the electrodes can be removed from solution, rinsed, and introduced into a new cell (10) comprising another batch of slurry (14) having uncoated particles. The overall size of the rotating cylinder slurry cell determines the quantity of particles that can be processed in a single batch of 200 ml to 2000 ml. A typical configuration is capable of processing 1 to 20 grams of particles in a single batch, but quantities are not so limited. In another embodiment, it is conceivable that the slurry (14) could be continuously fed into and out of the cell (10) where particles contained in the slurry (14) come into contact with the rotating electrode (18) so that an ultrathin film can be deposited.

The rotating cylinder slurry cell provides an additional control parameter during film deposition in the form of the rotation speed of the working electrode (11). By varying the rotation speed, flow within the cell can be changed between laminar and turbulent flow. This transition occurs at fairly low rotation rates such as, for example, 100 rotations per minute (rpm). The rotation speed also influences the duration of contact between the particles and the exposed surface of the rotating electrode (18) as well as the time required to deposit a film onto substantially all of the particles contained in a single batch. The rotation speed used is also influenced by the viscosity of the slurry which may be controlled based upon the ratio of the volume of particles to the volume of liquid. In embodiments where a slurry (14) is continuously fed into the cell (10), the flow rate and rotational speed of the working electrode (11) can be controllably adjusted to coat an appropriate fraction of the particles with the desired surface coverage.

### B. Underpotential Deposition and Galvanic Displacement

Having described the structure, function, and operation of the rotating cylinder slurry cell, processes by which the rotating cylinder slurry cell may be used to deposit ultrathin films will now be described in detail. The deposition process is centered around a series of electrochemical reactions which, when performed sequentially, result in an ultrathin film with the targeted surface coverage. In one embodiment, the procedure involves the initial formation of an adlayer of a material onto the surface of the particles by UPD. This is followed by the galvanic displacement of the adlayer by a more noble metal, resulting in the conformal deposition of a layer of the more noble metal on the substrate. It is to be understood, however, that although the rotating cylinder slurry cell is particularly advantageous for use during UPD growth, it is not limited to this particular growth technique and may be used for other electrochemical processes such as electroplating.

### Example 1

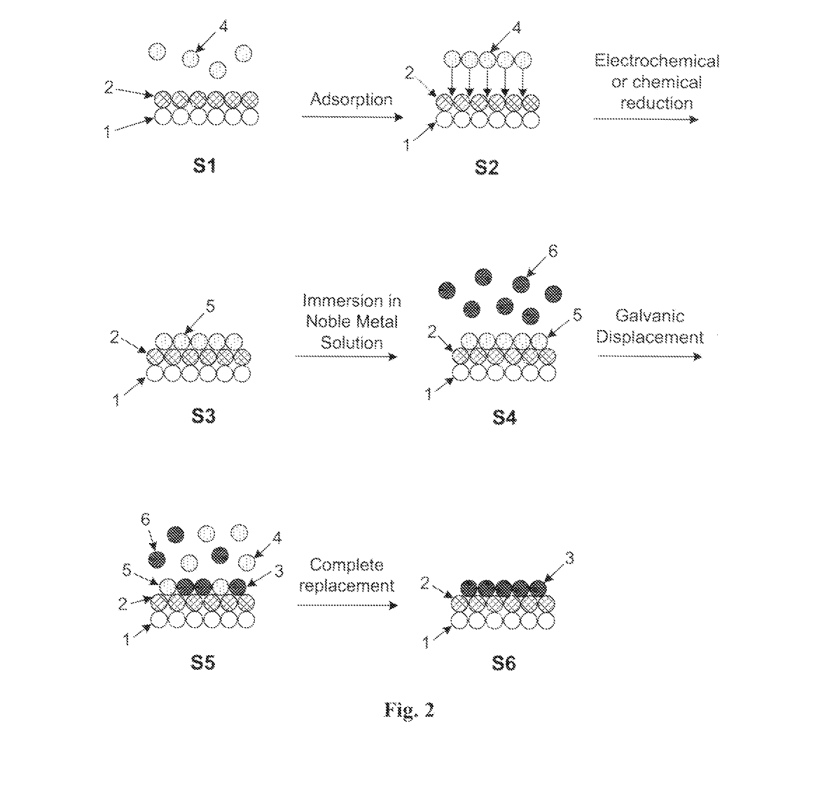

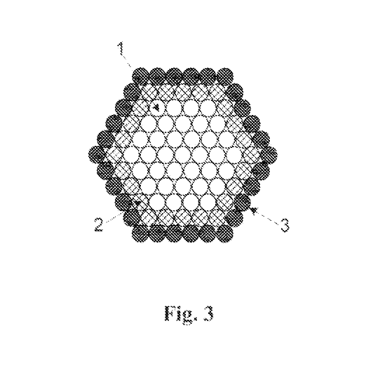

The present invention may be illustrated by way of exemplary embodiments. In this example, the deposition process will be described with reference to deposition onto non-noble metal-noble metal core-shell nanoparticles. The core-shell nanoparticles may be initially formed using any method known in the art including, for example, those disclosed in U.S. patent application Ser. No. 12/709,910. The deposition process in Example 1 will now be described using FIGS. 2 and 3 as a reference. The nanoparticle surface in FIG. 2 shows a portion of the non-noble metal core (1) along with the noble metal shell (2). Non-noble metal ions (4) are initially adsorbed on the surface by immersing the nanoparticles in a cell (10) comprising the appropriate concentration of non-noble metal ions (4) in step S1. The non-noble metal ions (4) are contained in solution within the slurry (14) illustrated in FIG. 1. Typical non-noble metal ions that may be used for UPD of an initial adlayer include, but are not limited to, copper (Cu), lead (Pb), bismuth (Bi), tin (Sn), cadmium (Cd), silver (Ag), antimony (Sb), and thallium (Tl).

By rotating the working electrode (11) at the desired angular velocity (0 to 500 rpm, preferably 10 to 200 rpm) and applying the appropriate potential (−1 to +1 V), film growth by UPD occurs whenever a core-shell particle contacts the exposed surface of the rotating electrode (18) and acquires the charge necessary for UPD. This leads to the adsorption of metal ions (4) on the nanoparticle surface in step S2 and the formation of a monolayer of the non-noble metal (5) in step S3. This monolayer forms a substantially continuous “skin” around the periphery of the core-shell nanoparticle. It is to be understood, however, that whether the initial UPD adlayer achieves submonolayer or monolayer surface coverages depends on the duration of the contact between the particle and the rotating electrode (18) as well as the applied potential. The duration of the contact is influenced by a number of factors including the rotation speed of the electrode, the shape and size of the particle, the viscosity of the slurry, and whether deposition proceeds in batch or continuous fashion. Although the reaction itself is fast, these other factors generally require that the process continue for 10 to 20 minutes and up to about 2 hours.

After formation of an initial non-noble metal adlayer by UPD is complete, the non-noble metal ions remaining in solution are removed by rinsing with deionized water. This helps to remove excess non-noble metal ions (4) present on the surfaces of the particles. The particles are typically maintained under a nitrogen or other inert atmosphere during transfer to inhibit oxidation of the freshly deposited non-noble metal adlayer (5). A solution comprising a salt of a more noble metal is added in step S4 where the more noble metal ions (6) contained in solution replace surface non-noble metal adatoms (5) via a redox reaction as illustrated in step S5. The more noble metal (6) acts as an oxidizing agent by accepting electrons from the non-noble metal. The simultaneous reduction of the more noble metal ions (6) to an adlayer of the more noble metal (3) results in the replacement of surface non-noble metal atoms (5) with the more noble metal atoms (3). For example, monolayers of a noble metal such as palladium, platinum, gold, iridium, ruthenium, osmium, or rhenium can be deposited by displacement of a less noble metal using salts of PdCl₂, K₂PtCl₄, AuCl₃, IrCl₃, RuCl₃, OsCl₃, or ReCl₃, respectively. The galvanic displacement process may be performed separately, within the same or a different rotating cylinder slurry cell. When performed in the rotating cylinder slurry cell, agitation of the solution can be facilitated by rotating the working electrode (11) at a predetermined rotation speed.

The final product is a core-shell nanoparticle with a “skin” comprising a monolayer of the more noble metal atoms as shown in step S6 and illustrated in FIG. 3. The encapsulated core-shell nanoparticle cross-section in FIG. 3 shows that all atoms are close-packed in a hexagonal lattice, resulting in a hexagonal shape. It is to be understood, however, that the crystallographic structure is not limited to that shown and described in FIG. 3. The cycle depicted in FIG. 2 may be repeated any number of times to deposit additional layers of the more noble metal (3) onto the surface of the core-shell nanoparticle to ensure complete coverage. Conversely, less than a monolayer of the non-noble metal (5) may be deposited during UPD such that submonolayer coverages of the noble metal (3) result. While only a portion of the surface of a single core-shell nanoparticle is illustrated in FIG. 2, it is to be understood that deposition occurs simultaneously on a large number of core-shell nanoparticles. The “skin” of atoms forms a continuous and conformal coverage of the entire available surface area of each nanoparticle.

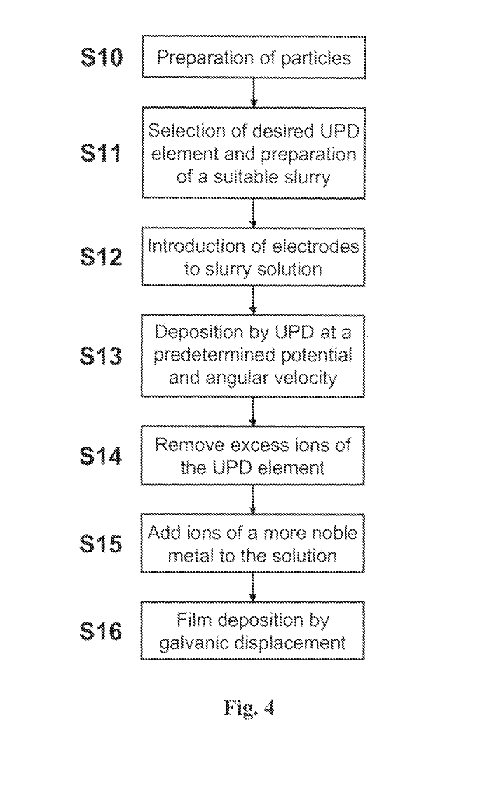

A generic description of UPD and galvanic displacement growth of ultrathin films using the rotating cylinder slurry cell will now be given in detail with reference to FIG. 4. The process flow illustrated in FIG. 4 is intended to describe a specific way of practicing the invention. However, it is to be understood that there are many possible variations which do not deviate from the spirit and scope of the present invention.

### Example 2

A second exemplary embodiment of the present invention will now be described in detail with reference to FIG. 4 which shows the overall process flow for film growth by UPD and galvanic displacement using a rotating cylinder slurry cell. Initially, in step S10, particles of the desired composition, size, and shape are formed. Such particles may also be purchased from commercial vendors, such as E-TEK (39 Veronica Av., Somerset, N.J., 08873) and BASF (Germany). The particles used may be of any type onto which atomic layers of the desired material may be deposited. In a preferred embodiment the particles are of the type described in Section I above. Prior to deposition of an initial adlayer by UPD, it is necessary to prepare a slurry comprising the particles and ions of the desired UPD element as shown in step S11. The UPD element must be a material which exhibits underpotential deposition such as, for example, any of Cu, Pb, Bi, Sn, Ce, Ag, Sb, and Tl.

In step S12 the electrodes comprising the rotating cylinder slurry cell are introduced into the slurry solution. This may be accomplished, for example, by physically placing the electrodes into the cell as in a batch process or by initiating flow of the slurry as in a continuous process. Deposition by UPD proceeds by rotating the working electrode at a predetermined rotational speed, e.g., between 0 and 500 rpm, preferably 10 to 200 rpm, and applying the appropriate electrode potential (−1 to +1 V) in step S13. If the process is in batch form, the electrode is rotated and the potential applied for a duration sufficient to form an adlayer on the desired fraction of particles. If the process is continuous, solution is continuously fed into and out of the cell where the desired fraction of particles is coated with an adlayer of the UPD element. In step S14, ions of the UPD element which are still in solution are removed such that ions of a more noble metal can be added in step S15. As in step S13, this can be done either in batch form or in a continuous manner. In step S16 the adsorbed atoms of the UPD element are replaced with atoms of the more noble metal by galvanic displacement to produce an ultrathin film of the noble metal. The process of galvanic displacement in step S16 may be accelerated by rotating the working electrode at a speed sufficient to agitate the solution. After deposition, the particles are emersed from solution, rinsed with deionized water, and blown dry. Steps S11 through S16 can be repeated as desired to deposit additional layers onto the plurality of particles.

It is envisioned that a plurality of rotating cylinder slurry cells may be used to deposit ultrathin films onto a large number of particles in a manner suitable for operation on a commercial scale. When in batch form, there may be a plurality of separate stations for preparing a slurry, depositing an initial adlayer by UPD, rinsing the particles, forming an ultrathin film by galvanic displacement, and then rinsing and drying the particles. Alternatively, a continuously operating line with a plurality of rotating cylinder slurry cells may be envisioned. During operation, each of the steps provide in FIG. 4 may be performed at a different station.

In a preferred application, particles coated using the process described in this specification may be used as the cathode in a fuel cell. This application is, however, merely exemplary and is being used to describe a possible implementation of the present invention. Implementation as a fuel cell cathode is described, for example, in U.S. patent application Ser. No. 12/709,910 to Adzic, et al. It is to be understood that there are many possible applications which may include, but are not limited to hydrogen sensors, charge storage devices, applications which involve corrosive processes, as well as various other types of electrochemical or catalytic devices.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. For example, larger cells with or without larger diameter working electrodes, may be employed to process significantly larger amounts of particles. That alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. Patents, and U.S. Patent Application Publications cited throughout this specification are hereby incorporated by reference as if fully set forth in this specification.

1-15. (canceled)

16. A method of forming a film on a plurality of microparticles or nanoparticles by electrodeposition, the method comprising: (a) preparing a slurry comprising the plurality of microparticles or nanoparticles and an electrolyte having a predetermined concentration, of ions of a material to be deposited as an adlayer; (in contacting with the slurry the apparatus according to claim 1; (c) rotating the first electrode at a predetermined rotational speed: and (d) applying a predetermined potential to the electrically conducive section of the first electrode tor a predetermined duration.

17. The method of claim 16 wherein the first electrode is rotated at a rotational speed of 100 rotations per minute.

18. The method of claim 16 wherein the applied potential is between −1 and +1 Volts.

19. The method of claim 18 wherein the predetermined duration is between 10 minutes and 2 hours.

20. The method of claim 16 wherein an adlayer of up to one monolayer is deposited on the surface of the microparticles or nanoparticles.

21. The method of claim 16 wherein the slurry is prepared using one to twenty grams of microparticles or nanoparticles in 200 ml to 2000 ml of electrolyte solution.

22. The method of claim 16 wherein the ions are selected from the group consisting of Cm, Pb, Bi, Sn, Ce, Ag, Sb, and Tl.

23. The method of claim 16 further comprising removing excess ions from the slurry after a predetermined potential has been applied to the first electrode.

24. The method of claim 23 further comprising adding ions of a metal which is more noble than the material deposited as an adlayer to the slurry to facilitate deposition of the more noble metal by galvanic displacement, and whereby the process of galvanic displacement results in deposition of the more noble metal.

25. The method of claim 24 wherein ions of a more noble metal are produced by adding a salt of one or more of PdCl₂, K₂PtCl₄, AuCl₃, IrCl₃, RuCl₃, OsCl₃, and ReCl₃, and whereby addition of the salt results in galvanic displacement of the material deposited as an adlayer by the more noble metal contained within the salt.

26. The method of claim 16 wherein the slurry is processed as a batch.

27. The method of claim 16 wherein the slurry is continuously fed to the apparatus for depositing ultrathin films using a predetermined flow rate.
